(19) United States
(12) Patent Application Publication
(10) Pub. No.: US 2026/0225006 A1
(43) Pub. Date: Aug. 6, 2026

(54) BRINE MINERAL PRECIPITATION EXTRACTION

(71) Applicant: NetZeroImpact LLC, Austin, TX (US)

(72) Inventors: Anand DEWAGAN, Austin, TX (US); James Patten, Sandy, UT (US)

(21) Appl. No.: 19/532,650

(22) Filed: Feb. 6, 2026

Related U.S. Application Data
(60) Provisional application No. 63/755,025, filed on Feb. 6, 2025.
(60) Provisional application No. 63/755,507, filed on Feb. 7, 2025.

(51) Int. Cl. B01D 21/30; B01D 21/00; B01D 21/01; B01D 21/24; C02F 1/00; C02F 1/66; C02F 101/10; C02F 101/12; C02F 101/20; C02F 103/00

(52) U.S. Cl. CPC B01D 21/305; B01D 21/009; B01D 21/01; B01D 21/2444; B01D 21/245; C02F 1/008; C02F 1/66; C02F 2101/101; C02F 2101/105; C02F 2101/12; C02F 2101/20; C02F 2103/007; C02F 2209/02; C02F 2209/06

(57) ABSTRACT

A brine mineral precipitator can include a settling tank with a solids collection mechanism and a solids outlet in a lower portion of the settling tank. An adjustable weir outlet can control outflow of brine from an upper portion of the settling tank. A recirculation pathway can be inside the settling tank and operatively couple to a recirculation pump to draw brine and solids upward from the lower portion of the settling tank. A brine inlet can be connected to the recirculation pathway and to a source of a pH-adjusting reagent, and configured to inject the pH-adjusting reagent into the recirculation pathway to be mixed with the brine.

### CROSS REFERENCE TO RELATED APPLICATIONS

This application claims priority to U.S. Provisional Application No. 63/755,025, filed Feb. 6, 2025, and U.S. Provisional Application No. 63/755,507, filed Feb. 7, 2025, wherein are hereby incorporated herein by reference.

### BACKGROUND

Saltwater bodies are found around the world. Other than the ocean, many smaller isolated saltwater bodies exist, including salt lakes and salt playas. These bodies of salt water can have varying salinity, and often can have a higher salinity than seawater. Many different minerals can be found in such bodies of salt water, such as lithium, magnesium, potassium, sulfur, and others. Although the water in these saltwater bodies may not be potable or directly used by humans, many such saltwater bodies support unique and vibrant ecosystems. Salt-tolerant plants can grow in wetlands around saltwater bodies. Organisms that live in the salt water itself, such as brine shrimp, can provide a food source for other animals. In particular, many species of birds often live in these ecosystems supported by the brine shrimp and plant life in saltwater bodies.

Unfortunately, some saltwater bodies face degradation due to changing climates and other causes related to human population. As an example, the Great Salt Lake in the United States is the largest saltwater lake in the western hemisphere. However, this lake has shrunk significantly over several decades. In the 1980's, the Great Salt Lake covered an area of 3,300 square miles. In recent years, the area covered by the lake has diminished to around 1,000 square miles or less. This can be attributed to various factors, including climate change due to greenhouse gas emissions, reduced rainfall, increasing temperatures, and increasing water consumption by human populations around the lake. Consequences of the lake shrinking may include destruction of wetlands ecosystems around the lake. As the water evaporates, the salinity of the water can increase. If the water reaches a high enough concentration, the algae and brine shrimp living in the lake may not be able to survive any longer. This can eliminate the food source for other animals in the ecosystem, including waterfowl and migratory birds. Additionally, some toxic materials are found in the water and the lake bed. Arsenic, antimony, copper, zirconium and other heavy metals can be found in the lake bed. Many of these are present due to mining and pollution of the lake and other water that eventually finds its way into the lake. Because the Great Salt Lake has no outlet, these materials have been effectively sequestered in the lake bed. However, as the waterline recedes and the lake bed dries, these toxic materials can be carried by the wind in dust storms. This can have a negative impact on the health of residents living near the lake. Thus, the shrinking volume of water and increasing salinity of the lake can pose a significant threat to plants, animals, and humans around the lake.

Lithium is increasingly in demand for use in lithium batteries. These can potentially enable more use of cleaner energy by providing energy storage for renewable energy technologies. Electric vehicles also have the potential to reduce greenhouse gas emissions by replacing gasoline and diesel powered vehicles. The use of such technologies can potentially alleviate some environmental issues, such as climate change. However, lithium sources are currently not able to match demand. Some lithium production processes involve pumping groundwater containing lithium into evaporation ponds and evaporating the water. Thus, in these processes a large amount of water is lost to evaporation.

### SUMMARY

The present technology involves brine mineral precipitators and methods and systems for extracting minerals from brine. This technology enables efficient recovery of minerals from high-salinity brines and can achieve near-zero liquid discharge and significant reductions in greenhouse gas emissions. The systems described herein can be modular, allowing for rapid deployment, cost efficiency, and adaptability across various operational scales.

In one example, a brine mineral precipitator can include a settling tank. A solids collection mechanism can be in a lower portion of the settling tank. A solids outlet can also be in the lower portion of the settling tank. An adjustable weir outlet can be configured to control outflow of brine from an upper portion of the settling tank. The precipitator can also include a recirculation pathway operatively coupled to a recirculation pump configured to draw brine and solids upward from the lower portion to the upper portion of the settling tank. A brine inlet can be connected to the recirculation pathway and to a brine source, and configured to direct brine into the recirculation pathway. The precipitator can also include a reagent inlet connected to the recirculation pathway and to a source of a pH-adjusting reagent, configured to inject the pH-adjusting reagent into the recirculation pathway to be mixed with the brine.

An example brine processing system can include a plurality of brine mineral precipitators connected in series. The individual brine mineral precipitators can include a settling tank, a solids outlet in the lower portion of the settling tank, an adjustable weir outlet configured to control outflow of brine from an upper portion of the settling tank, a brine inlet configured to introduce brine into the settling tank, and a reagent inlet configured to introduce a pH-adjusting reagent from a source of the pH-adjusting reagent into the settling tank to be mixed with the brine. A first brine mineral precipitator of the plurality of brine mineral precipitators can receive brine from an initial brine source through its brine inlet, and subsequent brine mineral precipitators in the series can receive brine from the adjustable weir outlet of a previous brine mineral precipitator in the series.

The present disclosure also describes brine mineral extraction methods. One example method can include introducing brine into a settling tank of a brine mineral precipitator. A pH-adjusting reagent can also be introduced into the settling tank. The pH-adjusting reagent can be mixed with the brine to adjust the pH of the brine, and a mineral can precipitate from the brine at the adjusted pH. The precipitated mineral can be allowed to settle to a lower portion of the settling tank, and the precipitated mineral can be recovered at a solids outlet in the lower portion of the settling tank. The brine can flow out from an upper portion of the settling tank through an adjustable weir outlet. In further examples, the method can also include flowing the brine from the adjustable weir outlet to a plurality of additional brine mineral precipitators in series. Additional pH-adjusting reagents can be introduced into settling tanks of the plurality of additional brine mineral precipitators. These pH-adjusting reagents can be mixed with the brine to precipitate additional minerals from the brine. The additional minerals can be recovered at solids outlets in lower portions of the additional brine mineral precipitators.

Another example brine mineral extraction method can include introducing brine from a brine source into a settling tank, wherein the brine source has a pH that is variable over time. The pH of the brine in the settling tank can be measured. The method can also include introducing a sufficient amount of a pH-adjusting reagent into the settling tank to selectively precipitate a mineral from the brine. The amount of pH-adjusting reagent introduced can be automatically controlled using a feedback loop with the measured pH of the brine in the settling tank. The precipitated mineral can be allowed to settle to a lower portion of the settling tank. The precipitated mineral can be recovered at a solids outlet in the lower portion of the settling tank. The brine can be recovered from an upper portion of the settling tank. In some examples, the brine source can have a pH from 6.0 to 14.0.

Another example brine processing system can include a brine intake adapted to withdraw brine from a natural body of salt water. At least one brine treatment unit can be configured to receive the withdrawn brine. Each treatment unit can be configured to induce precipitation of at least one dissolved constituent from the brine. At least one controller can be configured to monitor at least one brine parameter selected from pH, temperature, salinity, or composition and to control operation of the one or more brine treatment units. A solids removal subsystem can be configured to separate precipitated solids from the brine to form a treated brine. The system can also include a brine return pathway configured to return the treated brine to the natural body of salt water. The treated brine can have one or more of a reduced salinity and a reduced concentration of one or more dissolved metals or minerals compared to the withdrawn brine.

An example method of treating brine from a natural body of salt water can include withdrawing brine from a natural body of salt water. The withdrawn brine can be treated by monitoring and adjusting at least one operating condition selected from pH, temperature, or reagent addition to cause precipitation of at least one dissolved constituent from the brine. Precipitated solids can be separated from the brine leaving a treated brine. The treated brine can be returned to the natural body of salt water. The treated brine can exhibit at least one of a reduced salinity and a reduced concentration of one or more dissolved metals or minerals compared to the withdrawn brine.

These approaches can provide controlled, modular precipitation of multiple minerals from hypersaline brine using feedback-controlled pH and temperature adjustment within recirculating clarifier-type precipitators.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side schematic cross-sectional view of an example brine mineral precipitator, in accordance with an example of the present technology.

FIG. 2 is a side schematic cross-sectional view of another example brine mineral precipitator, in accordance with an example of the present technology.

FIG. 3 is a perspective view of an example serrated heating or cooling finned tube, in accordance with an example of the present technology.

FIG. 4 is a schematic view of an example brine processing system, in accordance with an example of the present technology.

FIG. 5 is a schematic view of another example brine processing system, in accordance with an example of the present technology.

FIG. 6 is a schematic view of another example brine processing system, in accordance with an example of the present technology.

FIG. 7 is a block diagram of an example brine processing method, in accordance with an example of the present technology.

FIG. 8 is a schematic view of an example belt press, in accordance with an example of the present technology.

FIG. 9 is a schematic side cross-sectional view of an example sludge dewatering centrifuge, in accordance with an example of the present technology.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “an inlet” includes reference to one or more of such components and reference to “precipitating” refers to one or more of such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” and “at least one of A, B or C” explicitly includes only A, only B, only C, or combinations of each.

As used herein, “brine” refers to an aqueous solution containing at least one dissolved salt. In certain examples, the brine can be provided from a natural source such as seawater, a salt lake, a salt playa, or other natural body of brine. In other examples, the brine can be provided from a man-made source, such as brine present in industrial tailings or other man-made sources.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Brine Mineral Precipitation Extraction

The technology described herein involves extracting minerals from brine, such as brine from a natural body of salt water or brine produced by industrial processes (i.e., brine present in industrial tailings). A variety of valuable minerals can be recovered from brine sources. The systems and methods described herein can allow these minerals to be recovered in a cost-efficient way. The brine mineral extraction methods described herein can include energy efficiency features that can reduce cost of energy, as well as features to conserve reagents and water. Thus, various minerals can be recovered in a profitable way.

In addition to the economic value, these systems and methods can be particularly useful because of their low environmental impact. The systems and methods can have little or no negative impact on the environment, and in some respects the systems and methods can have a net positive impact on the environment. In some cases, the methods can be performed with little or no net consumption of fresh water. This can be particularly useful in arid locations, which is a type of climate that surrounds some bodies of salt water that can be used as a source of brine. This is unlike other methods of recovering minerals from brine, which often include evaporating brine in evaporation ponds until most of the water content is lost to evaporation. The systems and methods described herein can also incorporate renewable energy resources in various ways.

The methods described herein can also contribute to the overall health of natural saltwater bodies and surrounding ecosystems. As mentioned above, some saltwater bodies have been challenged throughout recent history by dropping water levels, increasing salinity, increasing alkalinity, reduction of wetland areas, exposure of toxic metals as waterlines recede, and other issues. These can be caused by factors such as climate change, human water usage, and pollution. The methods described herein can be performed without further increasing the salinity of the saltwater body, and in some cases the methods can even reduce the salinity of the saltwater body. For example, water from the saltwater body can be processed using the systems and methods described herein, and then the water can be returned to the saltwater body. The processing can remove a variety of salts from the water, thus reducing the salinity of the water. Thus, these methods have the potential to reduce the overall salinity of the saltwater body over time. In some cases, the processing can also include removing heavy metals and toxic materials from the water, which can reduce the levels of toxic materials in the lake and lake bed. Some of the water can also be utilized to encourage growth of plants and repair ecosystems around the saltwater body.

In some examples, the systems and methods described herein can be used to extract lithium from the saltwater body. As mentioned above, lithium can be used in lithium batteries for energy storage to enable new environmentally friendly energy technologies. In this way, the systems and methods described herein can benefit the environment by facilitating renewable energy. The systems can also be integrated with renewable energy, such as solar electric generators and solar heating. Since many saltwater bodies are located in desert locations with mostly sunny weather, solar energy can be particularly useful to power these systems.

The systems and methods described herein can utilize brine mineral precipitators that can be configured to cause specific minerals to precipitate out of solution in brine. Brine can be sourced from a body of salt water or another brine source and introduced into the brine mineral precipitator. Minerals can be caused to precipitate from the brine in the precipitator by changing conditions such as temperature, adding reagents, or a combination thereof. Multiple precipitators can be modularly combined in a system to recover multiple different minerals from brine, or multiple precipitators can be used to recover a single type of mineral. In some examples, the precipitators can be connected in series and multiple different minerals can be precipitated out of the brine sequentially. The precipitators can share a common design in some examples, but can be configured to precipitate different minerals by adding different reagents or changing the temperature of the brine.

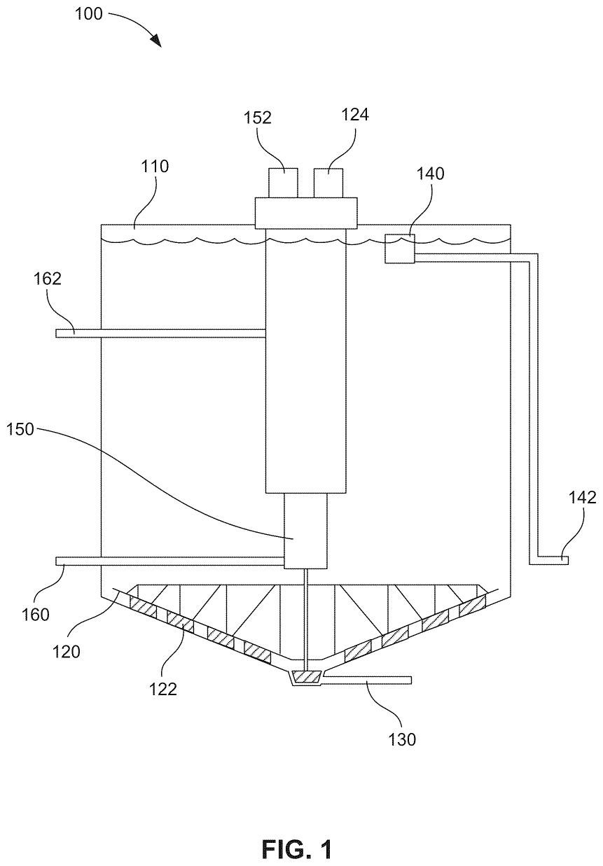

One example brine mineral precipitator is shown in FIG. 1. This figure shows a side schematic view of a precipitator 100, including a settling tank 110. A clarifier rake 120 is in a lower portion of the settling tank. This clarifier rake can rotate and help direct solids to a solids outlet 130 in the lower portion of the settling tank. The clarifier rake in this example includes scraper blades 122 that can scrape the bottom of the settling tank to help direct solids to the solids outlet. However, any suitable solids collection mechanism can be used of which a clarifier rake is one example. Other non-limiting examples of suitable solids collection mechanisms can include traveling scrapers (i.e. linear across rather than rotating), chain and flight collectors, plow assemblies, conical bottom floor, floor sludge hoppers, sludge pumps, hydrocyclone assisted or jet assisted underflow, screw conveyor, inclined plates, filter media, and the like. The clarifier rake can be rotated by a clarifier rake drive motor 124. The precipitator also includes an adjustable weir outlet 140 that can control outflow of brine from an upper portion of the settling tank. In this example, the adjustable weir outlet can include a floating weir that allows liquid brine to flow over the top of the weir, and then the brine can flow out through a brine outflow line 142. A draft tube 150 is inside the settling tank. The draft tube is connected to a recirculation pump 152 that can draw brine and solids upward from the lower portion of the settling tank. The brine and solids that are drawn up the draft tube in this way then circulated back down toward the bottom of the tank. Brine is introduced into the draft tube through a brine inlet 160 connected to the draft tube and to a brine source (not shown). The precipitator also includes a reagent inlet 162 connected to the draft tube and to a source of a pH-adjusting reagent (note shown). The reagent inlet can introduce the pH-adjusting reagent into the draft tube. The pH-adjusting reagent can then mix with the brine to adjust the pH of the brine. In some examples, the change in pH caused by introducing the pH-adjusting reagent can cause a mineral to precipitate from the brine.

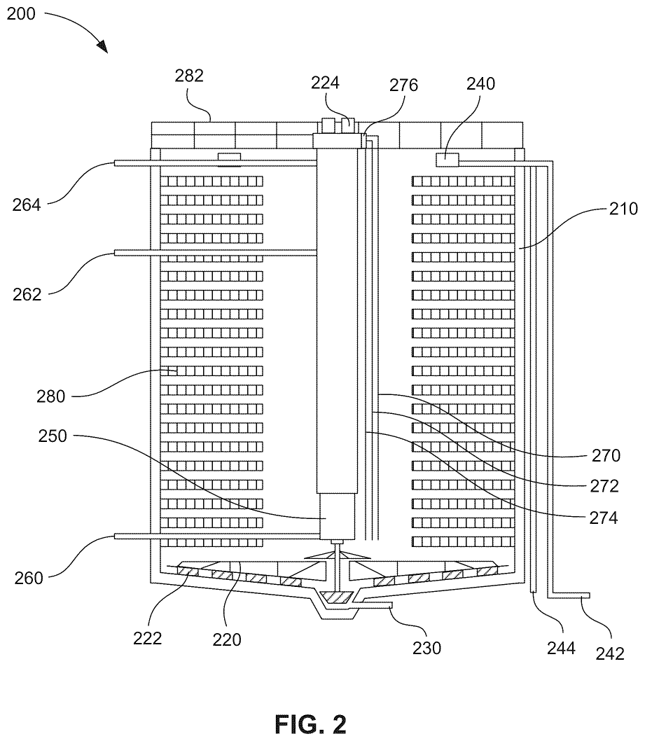

Another example brine mineral precipitator 200 is shown in FIG. 2. This example also includes a settling tank 210 with a clarifier rake 220 in a lower portion of the settling tank. The clarifier rake includes scraper blades 222 supported by rake arms. The clarifier rake is driven by a clarifier rake drive 224 at the top of the settling tank. A solids outlet 230 is at the bottom of the settling tank, which allows mineral concentrate solids to flow to a belt press or centrifuge to further separate the solids from the liquid. A draft tube 250 extends up the center of the settling tank. A brine inlet 260 is connected to the draft tube to introduce fresh brine into the draft tube. A CO₂ dosing inlet 262 is also connected to the draft tube. Carbon dioxide is one example of a pH-adjusting reagent that can be used to adjust the pH of the brine. This precipitator also includes an additional reagent inlet 264 that can be used to introduce catalytic, seeding, coagulant, anti-scaling, anti-fouling, anti-foaming reagents, or other reagents. An adjustable weir outlet 240 includes spider weir arms and a discharge collection ring connected to a brine outlet line that directs brine to the next stage (i.e., an additional precipitator connected in series). The outlet allows clarified brine to flow out a brine outlet 242, which can lead to a subsequent stage. The outlet is also connected to a flush outlet 244 that can be used when flushing the settling tank. This example also includes several sensors installed in the settling tank, including a mass spectrometer 270, a temperature monitor 272, and a pH monitor 274. These sensors are connected to a controller 276. Additionally, serrated finned heating or cooling finned tubes 280 are includes inside the settling tank. These can be used to heat or cool the brine in the settling tank. The settling tank also includes a bridge 282 to provide access to the controller and clarifier rake drive.

The draft tube illustrated in FIGS. 1 and 2 is one example of an internal circulation structure for inducing recirculation of brine within the settling tank. In alternative embodiments, recirculation of brine within the settling tank may be achieved using other circulation structures or flow paths, including external circulation conduits that withdraw brine from a lower portion of the settling tank and return the brine to an upper portion of the settling tank, or combinations of internal and external circulation. Accordingly, a recirculation pathway can be adapted to induce vertical recirculation of the brine and solids from the lower portion to the upper portion. In one example, the recirculation conduit can be non-centrally oriented within the settling tank (e.g. along or near an internal sidewall of the tank). Alternatively, the recirculation conduit can be at least partially oriented external to the settling tank (e.g. running from the lower portion through a sidewall to an exterior location, upwards, and then back into the settling tank at the upper portion.

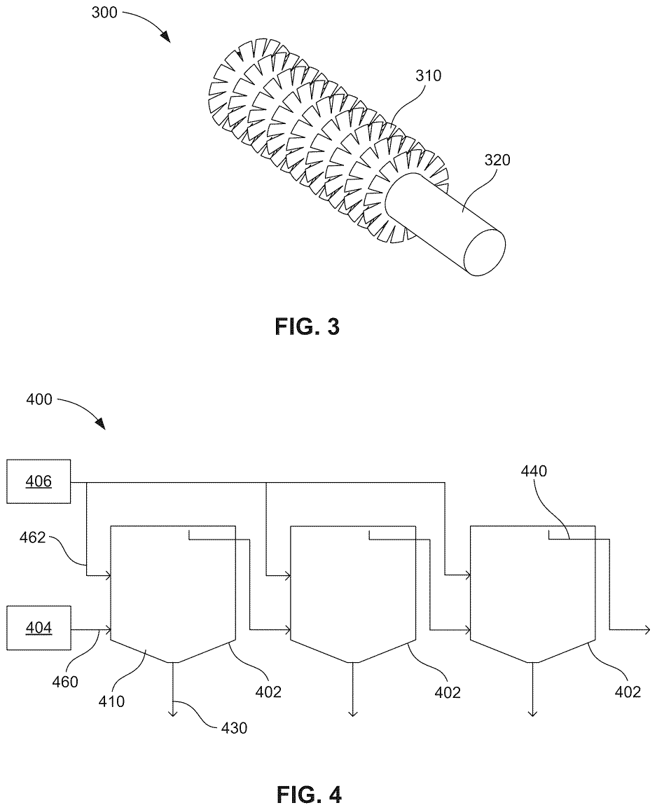

FIG. 3 shows an example of serrated finned heating or cooling finned tubes 300 that can be included in the settling tank. The serrated finned tube includes solid serrated fins 310 on the outside surface of a tube 320. The fins increase the heat transfer area of the tube, which can increase the rate of heat transfer to the brine in the settling tank. In certain examples, these tubes can be installed inside the settling tank, extending inward from an outer periphery of the settling tank. The tubes can be connected to a heat source or cooling source. For example, steam or hot water can be circulated through the tubes to heat brine in the settling tank, or cold water can be circulated through the tubes to cool the brine. In other examples, finned tubes with different types of fins can be used, such as non-serrated fins. In still further examples, non-finned tubes can be used, or any other type of heat exchange tubes or other heat exchanger can be used that is suitable for heating or cooling the brine in the settling tank. In various examples, a plurality of heat exchange tubes can extend inward from an outer wall of the settling tank. These heat exchange tubes can be configured to heat or cool the brine in the settling tank.

Multiple brine mineral precipitators can be connected in series so that brine flows from one precipitator into the next. The individual precipitators can be configured to cause minerals to precipitate from the brine. As an example, FIG. 4 is a schematic view of an example brine processing system 400 that includes a plurality of brine mineral precipitators 402. The individual brine mineral precipitators include a settling tank 410, a solids outlet 430 in a lower portion of the settling tank, and an adjustable weir outlet 440 configured to control outflow of brine from an upper portion of the settling tank. Each precipitator has a brine inlet 460 through which brine is introduced into each settling tank. In this system, the first precipitator in the series receives brine from an initial brine source 404 through the brine inlet. Subsequent precipitators in the series receive brine from the adjustable weir outlet of the previous precipitator in the series. This system also includes a source of a pH-adjusting reagent 406 connected to reagent inlets 462 of each precipitator. The reagent inlets are configured to introduce the pH-adjusting reagent from the source of the pH-adjusting reagent into the settling tanks to be mixed with the brine.

Sources of brine can include a body of salt water, seawater, groundwater, brine produced by an industrial process, or another source. In certain examples, the source of brine can be a body of salt water, such as a salt lake or salt playa. In some examples, the brine source can have a higher salinity than seawater. For example, the brine source can have a salinity of greater than 3.5%, or greater than 5%, or greater than 10%, or from about 5% to about 35%, or from about 10% to about 30%, or from about 10% to about 20%, or from about 10% to about 15%. In further examples, the outlet of a final brine mineral precipitator in the series can be connected to the body of salt water to return the brine back to the body of salt water after minerals have been removed. In some examples, the brine can have a lower salinity when it is returned to the body of salt water than when initially removed from the body of salt water. In certain examples, all the minerals can be removed from the brine such that the brine substantially becomes distilled water. This can be returned to the body of salt water in certain examples. In alternative examples, the distilled water can be used for other purposes, such as irrigating plants, for cooling or heating, drinking, or other purposes.

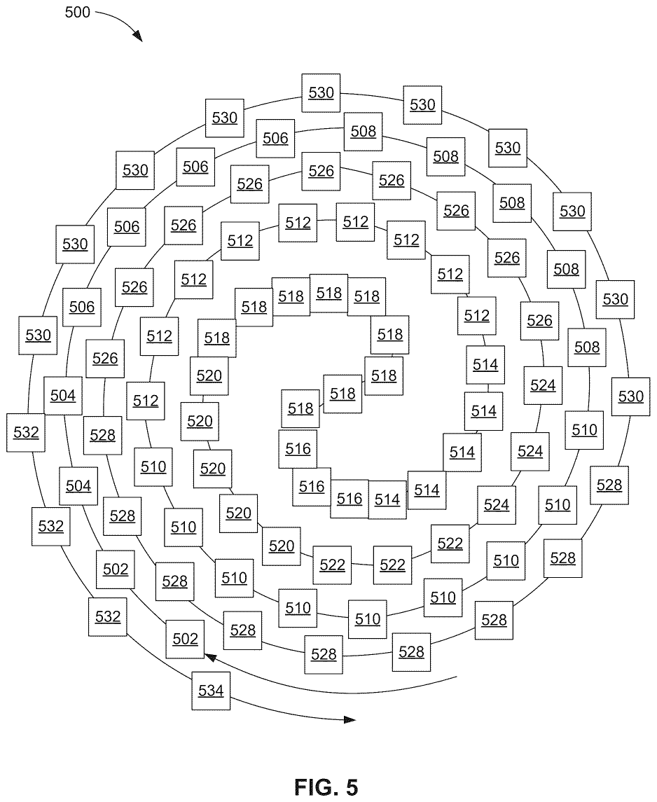

In some cases, brine mineral precipitators can be connected in series and each of the precipitators can be configured to selectively precipitate a different mineral. However, in other examples it can be useful to use two or more precipitators in the series for precipitating the same mineral. Any combination of any number of precipitators can be used to precipitate various minerals. FIG. 5 shows one particular example layout for a brine processing system 500 that includes various numbers of brine mineral precipitators in series for precipitating multiple different types of minerals. In this system, brine is sourced from a brine source such as a body of salt water. The brine is first filtered using coarse filtration units 502 and then ultrafiltration units 504 to remove solids. Organic biomass is then removed from the brine by organic biomass removal units 506. After this, the brine flows through a series of brine mineral precipitators that are used to cause various minerals to precipitate from the brine. In this example, the series of brine mineral precipitators includes: five precipitators for recovering struvite 508; nine precipitators for recovering magnesium carbonate 510; nine precipitators for recovering heavy metal hydroxides 512; five precipitators for recovering colemanite 514; three precipitators for recovering calcium carbonate 516; nine precipitators for recovering lithium carbonate 518; five precipitators for recovering magnesium oxide 520; three precipitators for recovering potassium sulfate 522; three precipitators for recovering potassium chloride 524; nine precipitators for recovering sodium carbonate 526; nine precipitators for recovering magnesium chloride 528; ten precipitators for recovering magnesium sulfate 530; and three precipitators for recovering anhydrous sodium sulfate 532. The brine stream then passes through a unit for recovering sodium hydroxide 534, which can operate by electrolysis in some examples. The brine then flows out of the system, and can be returned to the brine source or used for another purpose. In some examples, the series of precipitators can be arranged in a spiral shape, as in this example. In certain examples, the spiral shape can be a Fibonacci spiral. Furthermore, such a spiral pattern can minimize overall footprint, can allow for effective heat transfer between units, reduces piping crossovers, and can provide a progressive hydraulic gradient through sequential stages.

In some examples, the brine mineral separators can have a modular design. Multiple brine mineral separators can be used together in a system, where each of the brine mineral separators can have a similar design. For example, the brine mineral separators in a system can include settling tanks with the same size and volume. In some cases, additional settling tank volume can be desired for precipitating a given mineral. Instead of making a larger settling tank, it can be convenient to use several brine mineral precipitators with the same size of settling tank connected in series. In further examples, multiple precipitators can be connected in parallel to recover the same type of mineral in the multiple parallel precipitators. In some cases, connecting multiple precipitators in parallel can reduce the flow rate of brine through the parallel precipitators and provide more residence time in the settling tanks to allow the desired mineral to precipitate out of the brine. In certain examples, a system can be configured to precipitate multiple different minerals from brine, and each mineral can be precipitated using a precipitator or a group of precipitators. The precipitators or groups of precipitators can be connected in series to precipitate one mineral after another. Within a group of precipitators that are used to precipitate the same mineral, the individual precipitators in the group can be connected either in series or in parallel.

In some examples, the brine mineral precipitators can be sized to provide convenience in constructing a system. In certain examples, the brine mineral precipitators can be sized to fit on a standard flat bed trailer to be easily transportable to construction sites. In particular examples, the settling tank can have a diameter from about 5 ft. to about 12 ft. and/or a height from about 6 ft. to about 18 ft. In other examples, the settling tank can have a diameter from about 5 ft. to about 10 ft., or from about 10 ft. to about 12 ft., and a height from about 6 ft. to about 12 ft., or from about 12 ft. to about 19 ft. In further examples, the settling tank can have a diameter-to-height ratio from 1:2 to 1:1.

In some examples, the brine mineral precipitators can include a diffuse air inlet in the lower portion of the settling tank. This can include perforations in the bottom of the settling tank with a supply of air connected to the perforations. The air can be pumped in under pressure to prevent brine from leaking out through the perforations. Pumping diffuse air bubbles into the settling tank in this way can provide gentle mixing of the brine in the settling tank.

Because brines with high salinity can cause corrosion, the settling tanks and other equipment used in the systems described herein can include corrosion-resistant materials. In some examples, the settling tank can have a corrosion-resistant lining on an interior surface of the settling tank. The corrosion-resistant lining can include a polymer in some examples, such as nylon or epoxy. Other corrosion resistant linings can include, but are not limited to, ceramic coatings, resin coatings, metallic coatings, and the like. Similarly, self-cleaning coatings can be used to reduce fouling throughout the system, especially in heat exchangers and precipitators. Non-limiting examples of self-cleaning coatings can include polytetrafluoroethylene (PTFE), graphene, nano-coatings, and the like. In further examples, settling tank or other components such as the clarifier rake, draft tube, heat exchange tubes, and so on can be made from a corrosion-resistant metal. Some example corrosion-resistant metals include Hastelloy, stainless steel, duplex stainless steel, and others. Some specific example corrosion-resistant materials can include: Hastelloy® C-276 (available from Haynes International, Inc., USA), Hastelloy® C-22, SS 316L, SS 317L, Duplex 2205, Super Duplex 2507, Titanium Grade 2, and Inconel 625. These materials can have high durability in high-salinity and chemically aggressive conditions such as those encountered in brine processing and mineral precipitation systems.

As mentioned above, in some examples the brine mineral precipitator can include sensors to measure properties of the brine. In certain examples, the brine mineral precipitator can include a pH sensor configured to measure a pH of the brine in the settling tank. In further examples, a temperature sensor can be included to measure a temperature of the brine in the settling tank. In still further examples, a mass spectrometer can be included to measure a composition of the brine in the settling tank. These sensors can be positioned within the settling tank, under the surface of the brine in some examples. Alternatively, the sensors can be positioned above the surface of the brine or outside the settling tank, and a sampling tube can be connected to the sensors where the sampling tube can sample the brine in the settling tank.

In further examples, a controller can be used to monitor measurements made using the sensors described above. The controller can also be configured to adjust various parameters of the system in response to sensor measurements. In one example, the controller can be connected to a pH sensor and the pH sensor can provide pH measurement data to the controller. The controller can be configured to adjust the amount or rate of adding a pH-adjusting reagent to the brine. The controller can be programmed to maintain the brine within a pre-determined pH range by measuring the pH and adjusting the amount of pH-adjusting reagent using a feedback loop. In a similar example, the controller can be connected to a temperature sensor to receive temperature measurement data from the temperature sensor. The controller can be configured to adjust the temperature of the brine in the settling tank by increasing or decreasing heating or cooling of the brine. For example, the controller can be connected to a control valve to adjust flow of heating or cooling fluid through a heat exchanger that heats or cools the brine, such as the finned tubes described above. The controller can be programmed to maintain the brine within a pre-determined temperature range using a feedback loop. The controller can also be connected to a mass spectrometer that can analyze the composition of the brine in the settling tank. This can be useful to ensure that a particular chemical reaction is occurring as expected, or to detect changes in the chemical composition of the brine that may be due to natural variation in the saltwater body form which the brine is sourced. The controller can be programmed to adjust various parameters of the system in response to composition data received from the mass spectrometer. For example, the controller can be programmed to adjust the amount of pH-adjusting reagent added, or the temperature of the brine, or the addition of other reagents that are involved in the desired chemical reaction. In some alternatives, the controller can be governed using real time AI-driven process control. For example, AI-driven process control can be used for reagent dosing, pH balance, precipitation timing, mineral recovery yields, etc. Alternatively, or in addition, process control can be rule-based, PID control, model-based control, or other conventional control systems depending on system design criteria.

In various examples, pH-adjusting reagents can be used to make the brine more acidic (reducing the pH) or more basic (increasing the pH). In some examples, the pH-adjusting reagent can include carbon dioxide, which can make the brine more acidic. In other examples, the pH-adjusting reagent can include sodium hydroxide, which can make the brine more basic. Different minerals can precipitate out of solution from the brine when the pH is adjusted to different levels. Therefore, in some examples multiple brine mineral precipitators can be connected in series and configured to progressively increase the pH of the brine. Different minerals can precipitate out of the brine when the pH reaches different levels in this series. In other examples, the pH of the brine can be progressively reduced by the series of brine mineral precipitators.

In additional to the pH-adjusting reagent, the brine mineral precipitators can also include an inlet for an additional reagent or multiple additional reagents. In some examples, the reagent inlets can be connected to the draft tube in the brine mineral precipitator, so that the reagents can mix with the brine circulating in the draft tube. Some additional example reagents that can be added include catalyst, a seeding agent, a coagulant, a flocculant, an anti-scaling agent, an anti-fouling agent, an anti-foaming agent, a base, an acid, or a combination thereof. Some specific example reagents that can be used include, but are certainly not limited to, Na₂CO₃ (carbonate), NaOH (base), FeCl₃ (coagulant), Ca(OH)₂ (Ca source for CaMoO₄/CaWO₄), oxalic acid (for REE recovery), ferric sweep-floc, polymer flocculant, and combinations of these. These can be in liquid form in some examples. In certain examples, the brine mineral precipitator can include a gaseous reagent inlet and a liquid reagent inlet. The gaseous reagent inlet can be used to introduce a gaseous reagent, such as carbon dioxide. Any liquid reagents can be introduced through the liquid reagent inlet. In certain examples, the gaseous reagent inlet can be located part way up the settling tank, such as from about 50% to about 90% up the height of the settling tank. In further examples, the liquid reagent inlet can be located above the gaseous reagent inlet. In certain examples, the liquid reagent inlet can be located from about 80% to about 99% up the height of the settling tank.

Various pumps can be used to pump brine, reagents, air, heating or cooling fluid, and any other fluids involved in the system. In some examples, these can be integrated with individual brine mineral precipitators, or the pumps can be separate and integrated as part of a system. Example pumps can include a clog resistant brine inflow pump connected to the brine inlet, a clog resistant brine outflow pump connected to the adjustable weir outlet, a carbon dioxide dosing pump connected to the reagent inlet, a diffused air pump connected to a diffuse air inlet in the lower portion of the settling tank, or a combination thereof.

The following reaction pathways and mineral recovery examples are provided for purposes of illustration and enablement and are not intended to limit the scope of the disclosure. Other minerals, precipitation reactions, intermediate species, or recovery pathways may occur depending on brine composition, operating conditions, and reagent selection. Examples of minerals that can be extracted from brine using the systems described herein include struvite, magnesium carbonate, heavy metal hydroxide, colemanite, calcium carbonate, lithium carbonate, magnesium oxide, potassium sulfate, potassium chloride, sodium carbonate, magnesium chloride, magnesium sulfate, anhydrous sodium sulfate, and combinations thereof. In certain examples, a system can include a plurality of brine mineral precipitators including two or more of the following brine mineral precipitators connected in series in this relative order (meaning that even if the system does not include all these types of precipitators, the precipitators that are included will be ordered according to the following sequence): (1) a struvite precipitator, (2) a magnesium carbonate precipitator, (3) a heavy metal hydroxide precipitator, (4) a colemanite precipitator, (5) a calcium carbonate precipitator, (6) a lithium carbonate precipitator, (7) a magnesium oxide precipitator, (8) a potassium sulfate precipitator, (9) a potassium chloride precipitator, (10) a sodium carbonate precipitator, (11) a magnesium chloride precipitator, (12) a magnesium sulfate precipitator, and (13) an anhydrous sodium sulfate precipitator. In some examples, the series can include multiple precipitators that precipitate the same mineral. These can be adjacent to one another in the sequence, so that all precipitators that precipitate one type of mineral are grouped together. In other examples, various combinations of these brine mineral precipitators can be used in a different sequence.

Different conditions can be useful for precipitating different minerals. The conditions can include pH, temperature, and the addition of various reagents. In certain examples, a brine processing system can include any of the precipitators described above, and the conditions in the precipitators can be selected from the following: (1) the struvite precipitator contains brine at a pH from 8.0 to 9.0; or (2) the magnesium carbonate precipitator contains brine at a pH from 8.5 to 9.5 and injected carbon dioxide; or (3) the heavy metal hydroxide precipitator contains brine at a pH from 8.5 to 9.5; or (4) the colemanite precipitator contains brine at a pH from 9.2 to 9.5 and injected calcium hydroxide seeding agent; or (5) the calcium carbonate precipitator contains brine at a pH from 9.5 to 10.0 and a flocculant; or (6) the lithium carbonate precipitator contains brine at a pH from 10.5 to 11.0; or (7) the magnesium oxide precipitator contains brine at a pH from 10.5 to 11.5; or (8) the potassium sulfate precipitator contains brine at a pH from 7.0 to 8.0 and an injected coagulant; or (9) the potassium chloride precipitator contains brine at a pH from 7.0 to 8.0 and an injected flocculant; or (10) the sodium carbonate precipitator contains brine at a pH from 10.0 to 11.0; or (11) the magnesium chloride precipitator contains brine at a pH from 7.0 to 8.0 and injected non-ionic polyacrylamide; or (12) the magnesium sulfate precipitator contains brine at a pH from 7.0 to 8.0 and injected flocculant; or (13) the anhydrous sodium sulfate precipitator contains brine at a pH from 7.0 to 8.0; or a combination thereof. In further examples, the brine mineral precipitators can include conditions selected from: (8) the potassium sulfate precipitator maintains the brine at a temperature from 15° C. to 20° C.; or (9) the potassium chloride precipitator maintains the brine at a temperature from 10° C. to 12° C.; or (11) the magnesium chloride precipitator maintains the brine at a temperature from 4° C. to 6° C.; or (12) the magnesium sulfate precipitator maintains the brine at a temperature from 0° C. to 5° C.; or (13) the anhydrous sodium sulfate precipitator maintains the brine at a temperature below 0° C.; or the remaining precipitators maintain the brine at a temperature above 20° C.; or a combination thereof.

The chemical composition of brine can vary depending on the source, and a variety of reagents can be added to perform the methods described herein. Therefore, various different chemical reactions can occur when processing the brine. Non-limiting examples of chemical reactions that can occur in the precipitators described herein are described below. For cationic metals, some metals can be precipitated by hydroxide precipitation. This can include precipitation as a hydroxide, oxyhydroxide, oxide, hydrated oxide, and mixed-metal co-precipitate solids.

In some examples, in a struvite recovery precipitator, a reaction can take place between Mg²⁺, NH₄⁺, PO₄³⁻, and 6H₂O to form MgNH₄PO₄·6H₂O(s). In further examples, in a magnesium carbonate precipitator, a reaction can take place between Mg²⁺ and CO₃²⁻ to form MgCO₃(s). Additional downstream steps related to magnesium carbonate recovery can include forming MgO (by calcination), MgCl₂, Mg(OH)₂, or MgSO₄.

In still further examples, Cu can be precipitated as Cu(OH)₂. In other examples, Zn can be precipitated as Zn(OH)₂. When precipitating zinc, the pH can be maintained below 10 to avoid the formation of zincate. In further examples, Co can be precipitated as Co(OH)₂. In still further examples, Ni can be precipitated as Ni(OH)₂. In other examples, Cd can be precipitated as Cd(OH)₂. In still further examples, Pb can be precipitated as Pb(OH)₂, or PbO, or a mixture of these. A mixture can include lead oxide, lead hydroxide, lead oxyhydroxide, mixed precipitates, and/or complexes.

In other examples, Cr can be precipitated as Cr(OH)₃ or CrOOH. Cr can be Cr(III) in some examples. In other examples, oxidation reduction potential control can be applied to form other oxidation states. In cases where Cr(IV) is formed, a reduction step can be performed to reduce the Cr(IV) to Cr(III) prior to precipitation. In further examples, Mn can be precipitated as Mn(OH)₂ or MnOOH. In some cases, the removal of Mn can be improved by oxidation of the Mn to Mn(III) or Mn(IV) before precipitation. oxidation reduction potential control can also be applied to control the oxidation state of Mn.

In some examples, Sb can be precipitated as Sb(OH)₃ or Sb₂O₃. In certain examples, adsorption and co-precipitation onto ferric hydroxide/oxyhydroxide sweep-floc can help remove Sb.

In further examples, Tl can be precipitate as Tl(I) oxide or Tl(I) hydroxide or Tl(I) oxyhydroxide solids or mixed co-precipitates. These can form depending on pH, ionic strength, and co-precipitant availability.

In still further examples, Al can be precipitated at Al(OH)₃. When precipitating Al, the pH can be maintained from about 8.5 to about 9.5 to avoid aluminate formation.

Some metals can form oxyanion species. In some examples, these can be removed through sweep-floc capture. This can involve adsorption and co-precipitation onto ferric hydroxide or oxyhydroxide sweep-floc rather than formation of a discrete target hydroxide salt. In some examples, As can be removed in the form of AsO₃³⁻, AsO₄³⁻, H₂AsO₃⁻, HAsO₄²⁻, or a combination thereof. Se can be removed in the form of SeO₃²⁻, SeO₄²⁻, or a combination thereof. Mo can be removed in the form of MoO₄²⁻. Mo can also alternatively be removed in the form of CaMoO₄ by adding Ca. V can be removed in the form of VO₄³⁻, VO₃⁻, or a combination thereof. U can be removed in the form of UO₂(CO₃)ₓⁿ⁻ (a uranyl-carbonate complex). W can be removed in the form of WO₄²⁻ or CaWO₄ if calcium is added instead of using ferric hydroxide sweep-floc.

Some other metals can be removed in the form of sulfates, carbonates, or chlorides. For example, Ba can be removed in the form of BaSO₄, BaCO₃, or a combination thereof. Ag can be removed in the form of AgCl(s) in high-Cl brines. In some cases, Ag can be removed in the form of Ag₂O(s) or silver oxide or silver hydroxide depending on Cl activity and pH. Sr can be removed in the form of SrCO₃, SrSO₄, or a combination thereof.

In further examples, B can be removed in the form of Ca₂B₆O₁₁·5H₂O or H₃BO₃. Ca can react with CO₃²⁻ to form CaCO₃(s) for removal. Li can react with CO₃²⁻ to form Li₂CO₃(s) for removal. In some examples, K can be removed in the form of K₂SO₄ or KCl depending on the crystallization sequence used.

Rare earth elements can be converted to oxalates and then recovered. Notably, many rare earth elements can be valuable products used in various applications, such as catalysts, batteries, polishing, magnets, phosphors, MRI contrast, lasers, optical amplifiers, scintillators, and alloys. The rare earth elements (REE³⁺) can react with C₂O₄²⁻ to form a rare earth element oxalate (REE₂(C₂O₄)₃(s)). In certain examples, La can be removed in the form of La₂(C₂O₄)₃. In further examples, Ce can be removed in the form of Ce₂(C₂O₄)₃. In further examples, Pr can be removed in the form of Pr₂(C₂O₄)₃. In further examples, Nd can be removed in the form of Nd₂(C₂O₄)₃. In further examples, Sm can be removed in the form of Sm₂(C₂O₄)₃. In further examples, Eu can be removed in the form of Eu₂(C₂O₄)₃. In further examples, Gd can be removed in the form of Gd₂(C₂O₄)₃. In further examples, Tb can be removed in the form of Tb₂(C₂O₄)₃. In further examples, Dy can be removed in the form of Dy₂(C₂O₄)₃. In further examples, Ho can be removed in the form of Ho₂(C₂O₄)₃. In further examples, Er can be removed in the form of Er₂(C₂O₄)₃. In further examples, Tm can be removed in the form of Tm₂(C₂O₄)₃. In further examples, Yb can be removed in the form of Yb₂(C₂O₄)₃. In further examples, Lu can be removed in the form of Lu₂(C₂O₄)₃. In further examples, Y can be removed in the form of Y₂(C₂O₄)₃. In further examples, Sc can be removed in the form of Sc₂(C₂O₄)₃.

Titanium, zirconium, and tin can be removed in the form of hydrolysable tetravalent oxides. Ti can be removed in the form of TiO₂ or Ti(OH)₄ at a pH from 2 to 4. Zr can be removed in the form of ZrO₂ or Zr(OH)₄ at a pH from 2 to 4. Sn can be removed in the form of SnO₂ or Sn(OH)₄ at a pH from 2 to 5.

Gallium, indium, beryllium, and bismuth can form amphoteric hydroxides or oxides. In some examples, Ga can be removed in the form of Ga(OH)₃ or Ga₂O₃ at a pH from 4 to 8. In can be removed in the form of In(OH)₃ at a pH from 4 to 9. Be can be removed in the form of Be(OH)₂ at a pH from 6 to 8. Bi can be removed in the form of Bi(OH)₃ or Bi₂O₃ at a pH from 6 to 9.

In certain examples, Th can be removed in the form of Th(OH)₄ or ThO₂ at a pH from 3 to 5. In further examples, Nb can be removed in the form of Nb₂O₅·xH₂O at a pH from 2 to 4. In still further examples, Ge can be removed in the form of GeO₂·xH₂O at a pH from 4 to 7. For both Nb and Ge, the process can utilize hydrolysis-assisted precipitation or co-precipitation with sweep-floc or carrier solids, or a combination thereof. Controlling the pH and ionic strength can improve yield and solid-liquid separability.

Precious metals and platinum group metals can be removed using chemical reduction or electrowinning. In some examples, the system can include one or more reduction or electrowinning units for removing precious metals or platinum group metals. These metals can include Au, Pt, Pd, Rh, Ru, and Ir.

In further examples, Rb can be removed in the form of Rb₂CO₃ or RbCl. In still further examples, Cs can be removed in the form of CsCl or Cs formate. Additionally, Te can be removed as Te metal by reduction or cementation.

In some examples, one or more precipitators in the system can incorporate oxidation reduction potential (ORP) control. This can include an ORP sensor in the precipitator, an oxidizing agent and/or a reducing agent to be injected into the precipitator to adjust the ORP, or a combination thereof.

In one alternative, a sodium hydroxide precipitation step can be used for internal consumption. Specifically, sodium hydroxide (NaOH) can be produced using a three-membrane electrolyzer at an operating temperature of 90° C. and within a pH range of 13-14. This process provides a controlled supply of sodium hydroxide for on-site pH adjustments while maintaining efficiency in the overall brine treatment system. This sodium hydroxide precipitation can also be performed using any other suitable technique. Non-limiting examples of alternative sodium hydroxide precipitation can include bipolar membrane electrolysis, proton exchange membrane electrolysis, ion exchange resins, and the like.

In some examples, a brine processing system can include an electrolysis unit configured to recover sodium hydroxide from the brine by electrolysis. One or more brine mineral precipitators in the system can be configured to add sodium hydroxide to the brine to increase the pH of the brine. The electrolysis unit can be connected downstream of these brine mineral precipitators and configured to recover the sodium hydroxide so that the sodium hydroxide can be recycled and re-used in the brine mineral precipitators.

Some brine sources can have a varying pH over time. The variation in pH can be due to weather patterns, evaporation, water runoff, or other factors. In certain examples, the systems described herein can be configured to automatically monitor the pH of the brine and adjust the operation of the brine mineral precipitators accordingly. In certain examples, the brine source can have a pH that varies in the range from 6.0 to 14.0 or from 6.0 to 11.5. The brine mineral precipitator can include a pH sensor to measure the pH, and the pH sensor can be connected to a controller as described above.

The controller can be configured to adjust the pH in the precipitator in response to measured changes in the pH using a feedback loop. In some examples, this can be accomplished by introducing the pH-adjusting reagent to reduce the pH of the brine. The pH-adjusting reagent can include carbon dioxide, nitric acid, and sulfuric acid in some cases. In other examples, introducing the pH-adjusting reagent can increase the pH of the brine. In certain examples, the pH-adjusting reagent can include sodium hydroxide, Sodium Carbonate, or combinations thereof. Additional bases that may be used for increasing the pH of the brine can include: calcium hydroxide (Ca(OH)₂ or Slaked Lime); magnesium hydroxide (Mg(OH)₂—provides less aggressive pH adjustment while also introducing beneficial magnesium ions); potassium hydroxide (KOH—similar to sodium hydroxide but with the added benefit of potassium enrichment, if desirable); ammonium hydroxide (NH₄OH—can be used for selective precipitation, though volatility and ammonium discharge may be managed when using ammonium hydroxide); and barium hydroxide (Ba(OH)₂—can be useful in certain specialized applications involving sulfate removal).

In other cases, it can be desirable to introduce a pH-adjusting reagent which can reduce a pH of the brine. Such pH reducing reagents can include, but are not limited to, oxides of nitrogen and sulfur (e.g. sulfuric acid, sulfurous acid, nitric acid, etc.), hydrochloric acid, perchloric acid, acetic acid, carbonic acid, phosphoric acid, oxalic acid, citric acid, hydrofluoric acid, chromic acid, formic acid, lactic acid, malic acid, tartaric acid, butyric acid, ascorbic acid, fumaric acid, and gluconic acid, and the like. Acidic and basic chemicals, many of them available in natural or directly derived form, common to biological systems could also be considered, particularly if they can contribute to nutrition of life forms in the lake. Specific biologically relevant acids that could be utilized include, but are not limited to, acetic acid, lactic acid, citric acid, ascorbic acid (vitamin C), malic acid, tartaric acid, gluconic acid, succinic acid, pyruvic acid, and propionic acid. These acids can serve both as pH adjusters and as potential metabolic enhancers for microbial and algal growth in the ecosystem.

In some cases, the pH-adjusting reagent can be obtained from combustion of hydrocarbons. Combustion of hydrocarbons, as for example natural gas or coal fired power generation, typically produces from approximately 10% to 20% water concentration in the produced gas stream. When this produced water is removed from the gas stream (either as an independent process to simultaneously remove some of the regulated emissions, i.e. NOx, SOx, UHC, and PM, or as part of the process of capturing and sequestering CO₂) this produced water contains one or more of carbonic acid, nitric acid, and sulfuric acid in dilute concentrations. If allowed to escape to the atmosphere, these are the constituents of acid rain. Therefore, this produced and captured water can be introduced to the brine treatment system to lower pH and to form compounds with the metal constituents of the brine so that these compounds can be harvested, thus also removing the heavy metal constituents from the brine.

In further examples, the controller can also automatically adjust the temperature of the brine using a feedback loop by measuring the temperature of the brine and controlling heating or cooling of the brine. In certain examples the method can include measuring a temperature of the brine in the settling tank, heating or cooling the brine using a heat exchanger in the settling tank, and maintaining the brine in a pre-determined temperature range, wherein the heating or cooling is automatically controlled using a feedback loop with the measured temperature.

In further examples, brine processing methods can include heating or cooling the brine and precipitating minerals from the brine while recovering at least a portion of water used in the process. Water can be converted water vapor in the method through evaporation of the brine in the settling tanks, or through evaporation of water to make steam for heating, or evaporation of cooling water, among other pathways. In certain examples, at least a portion of the water vapor generated by the method can be recovered as liquid water using mechanical vapor recompression (MVR), thermal vapor recompression (TVR), or a combination thereof. In particular examples, the recovered portion of the water vapor can be from 90% to 98% of a total amount of water vapor generated by the method. The recovered liquid water can be reused in the heat exchangers or brine mineral precipitators, or released into a body of salt water, or a combination thereof. Releasing the recovered liquid water into a body of salt water can be useful to reduce the salinity of the body of salt water. This method can also utilize waste heat or heat generated through renewable energy to make the method more environmentally friendly. In some examples, the heating can utilize industrial waste heat, waste heat from a datacenter, heat from solar energy, or a combination thereof.

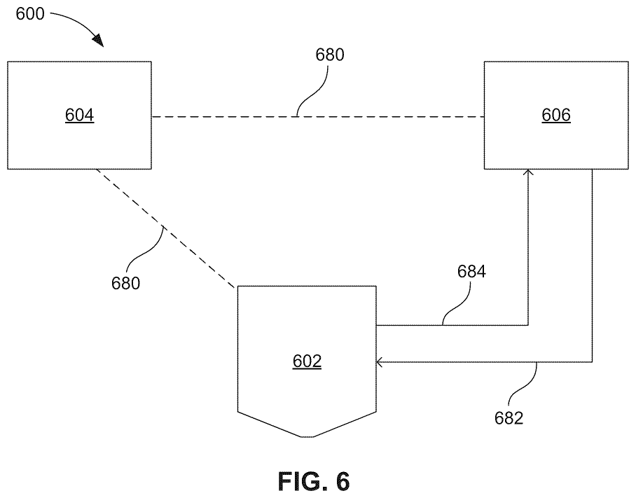

FIG. 6 shows an example system 600 that includes a brine mineral precipitator 602, a solar energy array 604, and a datacenter 606. These components are integrated to allow brine processing in a very energy efficient way. The solar array is electrically connected through electric lines 680 to the brine mineral precipitator and the datacenter to provide electric power to both the brine mineral precipitator and the datacenter. The datacenter provides waste heat through a waste heat stream 682 to the brine mineral precipitator. This can be connected to a heat exchanger, such as the heating/cooling tubes describes above in the brine mineral precipitator. The brine mineral precipitator provides cooling water through a cooling water stream 684 to the datacenter. In this way, renewable energy can be used to provide data processing and brine processing while efficiently utilizing waste heat and providing cooling to the datacenter.

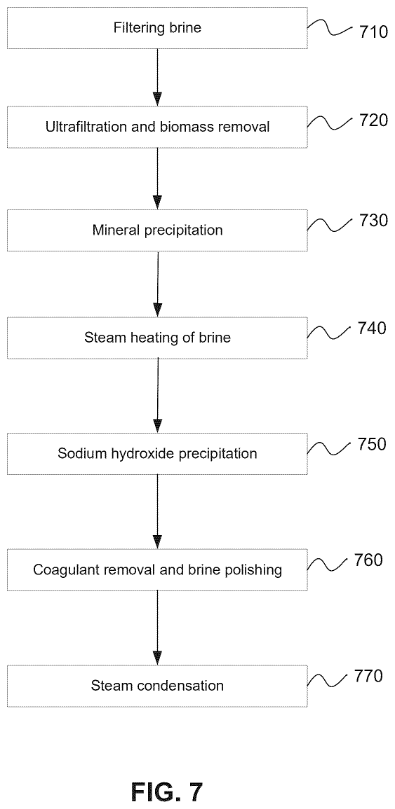

FIG. 7 is a block diagram showing another example sequence of operations for processing brine, although other configurations can be used. In this example, the brine is filtered 710, followed by ultrafiltration and biomass removal 720. Minerals are then precipitated 730 from the brine including: struvite, magnesium carbonate, heavy metal hydroxide, colemanite, calcium carbonate, lithium carbonate, magnesium oxide, potassium sulfate, potassium chloride, sodium carbonate, magnesium chloride, and anhydrous sodium sulfate. The brine is then heated with steam 740 from −5° C. to 90° C. Sodium hydroxide is then precipitated 750 from the brine. Then coagulants are removed and the brine is polished 760. Remaining steam can be condensed 770 using MVR or TVR.

Filtering brine 710 can involve an initial coarse filtration step to remove large particulate matter, organic debris, and suspended solids, followed by fine filtration to prevent clogging in downstream precipitation stages. In ultrafiltration and biomass removal 720, ultrafiltration can be applied to eliminate bacteria, algae, and organic biomass, providing stability in subsequent precipitation reactions by preventing pH fluctuations and unwanted organic interactions.

During mineral precipitation 730, a series of controlled precipitators can selectively remove key dissolved minerals by adjusting pH, temperature, and reagent dosing. The precipitation steps can include struvite formation at a pH of 8.0-9.0, magnesium carbonate precipitation at 8.5-9.5 with CO₂ injection, heavy metal hydroxides at 8.5-9.5, colemanite precipitation at 9.2-9.5 using calcium hydroxide seeding, calcium carbonate precipitation at 9.5-10.0 with flocculant, lithium carbonate at 10.5-11.0, magnesium oxide at 10.5-11.5, potassium sulfate at 7.0-8.0 with coagulant, potassium chloride at 7.0-8.0 with flocculant, sodium carbonate at 10.0-11.0, magnesium chloride at 7.0-8.0 with non-ionic polyacrylamide, magnesium sulfate at 7.0-8.0 with flocculant, and anhydrous sodium sulfate at 7.0-8.0.

Steam heating of the brine 740 can be carried out using mechanical vapor recompression (MVR) or thermal vapor recompression (TVR) systems to elevate the brine temperature from −5° C. to 90° C., which optimizes solubility, reaction kinetics, and selectivity for further precipitation processes. This heating stage is a precursor to sodium hydroxide precipitation 750. Sodium hydroxide can be precipitated internally using a three-membrane electrolyzer at an operating temperature of 90° C. and a pH range of 13-14, although other sodium hydroxide recovery options can be used. The internally produced sodium hydroxide can be utilized for pH adjustment within the system, reducing dependence on external reagents while enhancing process efficiency.

Following sodium hydroxide precipitation, coagulant removal and brine polishing 760 can be conducted through clarification and filtration steps to remove residual flocculants, coagulants, and trace impurities, ensuring high-purity brine before final water recovery. The remaining steam is condensed 770 using MVR or TVR, allowing for 90-98% water recovery, which can be reused within the system or returned to the brine source to manage salinity levels.

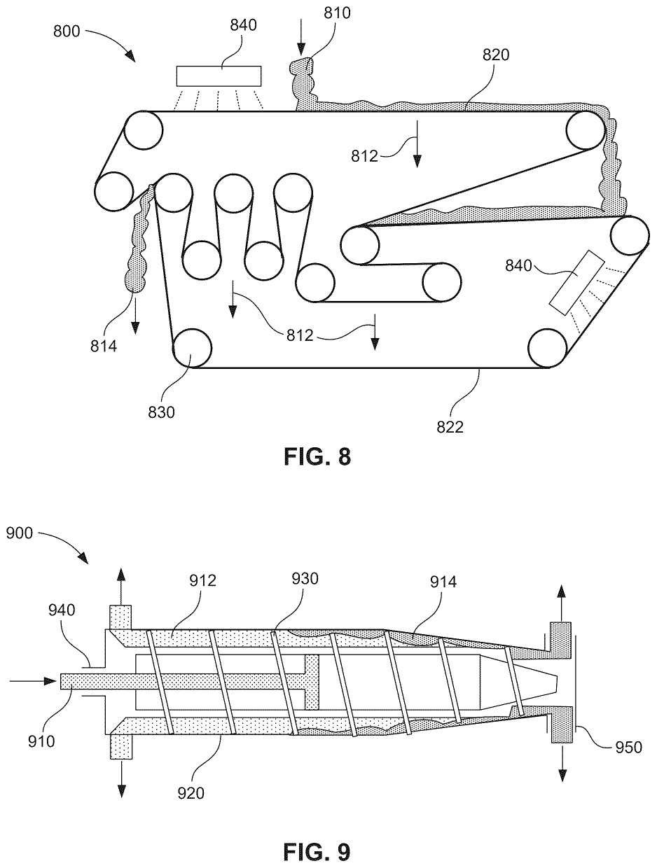

FIG. 8 is a schematic illustration of an example belt press 800 that can be used to dewater the mineral concentrate that includes precipitated mineral solids recovered from the bottom of the brine mineral precipitator settling tanks. Mineral concentrate 810 can be fed onto an upper belt 820. The upper belt can be water-permeable, allowing some filtrate 812 to drain from the mineral concentrate through the upper belt. The upper belt is then brought together with a lower belt 822, compressing the mineral concentrate between the upper belt and lower belt. The two belts are fed together through a series of rollers 830, which apply pressure to the mineral concentrate between the belts. Additional filtrate drains through the belts as the mineral concentrate is compressed. The dewatered mineral concentrate 814 is then recovered after the belts separate. The belts recirculate around the rollers, and belt washers 840 are used to wash the belts before the belts compress additional mineral concentrate.

FIG. 9 is a schematic illustration of an example sludge dewatering centrifuge 900 that can be used to dewater the mineral concentrate. This can be used as an alternative or in combination with the belt press of FIG. 8. This dewatering centrifuge includes a rotating bowl 920 that forms an outer shell. The bowl rotates at a sufficient speed to maintain mineral concentrate at the inner surface of the bowl by centrifugal force. A rotating screw conveyor 930 is inside the bowl. Mineral concentrate 910 is introduce through an inlet 940. The screw conveyor carries solids 914 toward a dewatered mineral concentrate outlet 950. Centrate 912 is separated from the solids, and flows out a centrate outlet at the opposite end of the centrifuge.

The systems and methods described herein can be used to reduce salinity and concentration of dissolved metals and minerals in natural bodies of salt water. In some natural bodies of salt water, this can improve the health of the body of salt water and the ecosystem in and around the body of salt water. The present technology can include systems and methods for withdrawing brine from a natural body of salt water, removing dissolved salts, metals, and other minerals from the brine, and then returning the brine to the body of salt water.

One example brine processing system can include a brine intake adapted to withdraw brine from a natural body of salt water. At least one brine treatment unit can be configured to receive the withdrawn brine. Each brine treatment unit can be configured to induce precipitation of at least one dissolved constituent from the brine. In some examples, the brine treatment unit can include a precipitator as described above. The system can also include at least one controller configured to monitor at least one brine parameter selected from pH, temperature, salinity, or composition. These parameters can be measured using sensors such as pH sensors, mass spectrometers, temperature sensors, and other sensors. The controller can also control operation of the one or more brine treatment units. The system can also include a solids removal subsystem configured to separate precipitated solids from the brine to form a treated brine. In some examples, the solids removal subsystem can include a clarifier rake, a solids outlet in a lower portion of the brine treatment unit, a belt press, a dewatering centrifuge, or other solids removal components. The system can also include a brine return pathway configured to return the treated brine to the natural body of salt water. When compared with the original withdrawn brine, the treated brine can have a reduced salinity, a reduced concentration of one or more dissolved metals or minerals, or a combination thereof.

An example method of treating brine from a natural body of salt water can include withdrawing brine from the natural body of salt water and treating the brine by monitoring and adjusting at least one operating condition selected from pH, temperature, or reagent addition to cause precipitation of at least one dissolved constituent from the brine. The precipitated solids can be separated from the brine, leaving a treated brine. The treated brine can then be returned to the natural body of salt water. The treated brine can exhibit at least one of a reduced salinity and a reduced concentration of one or more dissolved metals or minerals compared to the withdrawn brine. In various examples, methods of treating brine in this way can be performed using the precipitators described herein, having any of the features described herein.

### EXAMPLES

One example brine processing system includes the following series of brine mineral precipitators:
1. A settling tank system for Struvite precipitation, comprising: adjusting pH to 8.0 to 9.0 using automated reagent dosing; solids collection mechanism designed for solid-liquid separation; diffused air pumps for mixing and uniform brine distribution.
2. A settling tank system for Magnesium Carbonate precipitation, comprising: injecting CO₂ to enhance carbonate availability; maintaining pH at 8.5 to 9.5 for optimal precipitation; incorporating real-time pH and temperature monitoring.
3. A settling tank system for Heavy Metal Hydroxides precipitation, comprising: adjusting pH to 8.5 to 9.5; automated sludge removal systems for continuous operation; ensuring precise reagent dosing for optimal precipitation of trace heavy metals.
4. A settling tank system for Colemanite precipitation, comprising: adjusting pH to 9.2 to 9.5; introducing calcium hydroxide as a seeding agent; enhancing crystal growth via controlled temperature and agitation.
5. A settling tank system for Calcium Carbonate precipitation, comprising: adjusting pH to 9.5 to 10.0 using sodium carbonate; incorporating flocculants to accelerate settling rates; ensuring complete separation of calcium carbonate solids.
6. A settling tank system for Lithium Carbonate precipitation, comprising: adjusting pH to 10.5 to 11.0 using precision dosing systems; real-time monitoring of lithium yield efficiency; automated control of brine residence time to optimize precipitation.
7. A settling tank system for Magnesium Oxide precipitation, comprising: adjusting pH to 10.5 to 11.5 using sodium hydroxide; maintaining optimal agitation to prevent fouling; continuous sludge removal to streamline operations.
8. A cooling tank system for Potassium Sulfate precipitation, comprising: adjusting pH to 7 to 8 using CO₂ dosing; maintaining temperatures between 15° C. and 20° C.; using coagulants to enhance crystal separation; monitoring sulfate ion levels to optimize yield.
9. A cooling tank system for Potassium Chloride precipitation, comprising: maintain pH at 7 to 8; maintaining temperatures between 10° C. and 12° C.; adjusting brine composition to prevent co-precipitation; incorporating polymeric flocculants for enhanced separation.
10. A settling tank system for Sodium Carbonate precipitation, comprising: adjusting pH to 10.0 to 11.0 using sodium hydroxide; controlling temperature to maximize carbonate yield; automated dosing systems for precise reagent control.
11. A cooling tank system for Magnesium Chloride precipitation, comprising: adjusting pH to 7 to 8 using CO₂ dosing; maintaining temperatures at 5° C.; enhancing separation using non-ionic polyacrylamide; ensuring scalability for high-volume brine flows.
12. A cooling tank system for Magnesium Sulfate precipitation, comprising: maintain pH at 7 to 8; maintaining temperatures between 0° C. and 5° C.; using flocculants to prevent particle agglomeration; real-time monitoring of magnesium and sulfate ion concentrations.
13. A cooling tank system for Anhydrous Sodium Sulfate precipitation, comprising: maintain pH at 7 to 8; maintaining temperatures below 0° C.; optimizing brine composition for high sulfate recovery; ensuring compatibility with downstream brine polishing systems.
14. A multi-stage electrolysis system for Sodium Hydroxide recovery, comprising: raise the temperatures to 90° C. and maintain steady temperatures; adjusting pH to 13.0 to 14.0 using CO₂ dosing; production using a 3-membrane electrolyzer system; incorporating advanced catalytic agents for efficient electrolysis; real-time monitoring of energy input and sodium hydroxide yield.

An example method of removing heavy metals from hypersaline brine can include the following steps: (a) receiving brine into a mixing zone of a precipitator/clarifier; (b) adding base to adjust pH to 8.5-9.5; (c) adding ferric salt to generate Fe(OH)₃/FeOOH sweep-floc; (d) precipitating cationic metals as hydroxide/oxyhydroxide/oxide solids; (e) capturing oxyanion species by adsorption/co-precipitation onto sweep-floc; (f) settling and withdrawing solids; (g) dewatering and discharging clarified brine.

An example heavy metal removal system can remove heavy metals from hypersaline brine by hydroxide precipitation and ferric sweep-floc capture. The system can include: (a) precipitator/clarifier with mixing zone; (b) base injection for pH control (8.5-9.5); (c) ferric salt injection for sweep-floc; (d) optional Ca injection for CaMoO₄/CaWO₄; (e) pH sensor and controller; (f) optional ORP control; (g) clarifier with solids collection mechanism; (h) dewatering apparatus.

An example heavy metal concentrate prepared from hypersaline brine can include: (i) hydroxide/oxyhydroxide/oxide solids of Cu, Zn, Co, Ni, Cd, Pb, Cr, Mn, Sb, Tl, Al, or a combination thereof; (ii) adsorbed/co-precipitated species of As, Se, Mo, V, U, W, or a combination thereof, on Fe(OH)₃ floc; (iii) optionally BaSO₄, AgCl, SrCO₃ solids, or a combination thereof.

### ADDITIONAL EXAMPLES

The technology described herein can also include any of the following enumerated examples:
1. A brine mineral precipitator comprising:
   a settling tank;
   a solids collection mechanism. in a lower portion of the settling tank;
   a solids outlet in the lower portion of the settling tank;
   an adjustable weir outlet configured to control outflow of brine from an upper portion of the settling tank;
   a recirculation pathway operatively coupled to a recirculation pump configured to draw brine and solids upward from the lower portion of the settling tank to the upper portion;
   a brine inlet connected to the draft tube and to a brine source, configured to direct brine into the draft tube; and
   a reagent inlet connected to the draft tube and to a source of a pH-adjusting reagent, configured to inject the pH-adjusting reagent into the draft tube to be mixed with the brine.
2. The brine mineral precipitator of any of examples 1-20, or the system of any of examples 21-38, or the method of any of examples 39-62, wherein the settling tank has a diameter-to-height ratio from 1:2 to 1:1.
3. The brine mineral precipitator of any of examples 1-20, or the system of any of examples 21-38, or the method of any of examples 39-62, wherein the settling tank has a diameter from about 5 ft. to about 12 ft.
4. The brine mineral precipitator of any of examples 1-20, or the system of any of examples 21-38, or the method of any of examples 39-62, wherein the settling tank has a height from about 6 ft. to about 18 ft.
5. The brine mineral precipitator of any of examples 1-20, or the system of any of examples 21-38, or the method of any of examples 39-62, further comprises a diffuse air inlet in the lower portion of the settling tank.
6. The brine mineral precipitator of any of examples 1-20, or the system of any of examples 21-38, or the method of any of examples 39-62, further comprising a corrosion-resistant lining on an interior surface of the settling tank.
7. The brine mineral precipitator of any of examples 1-20, or the system of any of examples 21-38, or the method of any of examples 39-62, wherein the corrosion-resistant lining comprises nylon, epoxy resin, or a combination thereof.
8. The brine mineral precipitator of any of examples 1-20, or the system of any of examples 21-38, or the method of any of examples 39-62, wherein the solids collection mechanism is one or more of a clarifier rake, traveling scraper, chain and flight collector, plow assembly, conical bottom floor, floor sludge hopper, sludge pump, hydrocyclone assisted underflow, jet assisted underflow, screw conveyor, inclined plates, and filter media.
9. The brine mineral precipitator of any of examples 1-20, or the system of any of examples 21-38, or the method of any of examples 39-62, further comprising a pH sensor configured to measure a pH of brine in the settling tank.
10. The brine mineral precipitator of any of examples 1-20, or the system of any of examples 21-38, or the method of any of examples 39-62, further comprising a controller in communication with the pH sensor configured to change an amount of the pH-adjusting reagent that is injected into the draft tube to achieve a predetermined pH level in the brine.
11. The brine mineral precipitator of any of examples 1-20, or the system of any of examples 21-38, or the method of any of examples 39-62, further comprising a temperature sensor configured to measure a temperature of brine in the settling tank.
12. The brine mineral precipitator of any of examples 1-20, or the system of any of examples 21-38, or the method of any of examples 39-62, further comprising a mass spectrometer configured to measure a composition of brine in the settling tank.
13. The brine mineral precipitator of any of examples 1-20, or the system of any of examples 21-38, or the method of any of examples 39-62, wherein the pH adjusting reagent comprises carbon dioxide.
14. The brine mineral precipitator of any of examples 1-20, or the system of any of examples 21-38, or the method of any of examples 39-62, wherein the pH adjusting reagent comprises a liquid solution.
15. The brine mineral precipitator of any of examples 1-20, or the system of any of examples 21-38, or the method of any of examples 39-62, wherein the reagent inlet is a gaseous reagent inlet configured to inject one or more gaseous reagents into the recirculation pathway.
16. The brine mineral precipitator of any of examples 1-20, or the system of any of examples 21-38, or the method of any of examples 39-62, further comprising a liquid reagent inlet connected to the recirculation pathway and to a source of a liquid reagent, configured to inject the liquid reagent into the recirculation pathway to be mixed with the brine.
17. The brine mineral precipitator of any of examples 1-20, or the system of any of examples 21-38, or the method of any of examples 39-62, wherein the liquid reagent comprises a catalyst, a seeding agent, a coagulant, a flocculant, an anti-scaling agent, an anti-fouling agent, an anti-foaming agent, a base, an acid, or a combination thereof.
18. The brine mineral precipitator of any of examples 1-20, or the system of any of examples 21-38, or the method of any of examples 39-62, further comprising a plurality of heat exchange tubes extending inward from an outer wall of the settling tank configured to heat or cool the brine in the settling tank.
19. The brine mineral precipitator of any of examples 1-20, or the system of any of examples 21-38, or the method of any of examples 39-62, wherein the heat exchange tubes comprise serrated fins extending radially from the heat exchange tubes.
20. The brine mineral precipitator of any of examples 1-20, or the system of any of examples 21-38, or the method of any of examples 39-62, further comprising: a clog resistant brine inflow pump connected to the brine inlet, a clog resistant brine outflow pump connected to the adjustable weir outlet, a carbon dioxide dosing pump connected to the reagent inlet, a diffused air pump connected to a diffuse air inlet in the lower portion of the settling tank, or a combination thereof.
21. The brine mineral precipitator of any of examples 1-20, or the system of any of examples 22-38, or the method of any of examples 39-62, wherein the recirculation pathway has an inlet in the lower portion and an outlet in the upper portion, and is a draft tube centrally oriented inside the settling tank, or is a recirculation conduit which is non-centrally oriented, or is a recirculation conduit which is at least partially oriented external to the settling tank.
21. A brine processing system, comprising:
   a plurality of brine mineral precipitators connected in series, wherein individual brine mineral precipitators comprise:
      a settling tank,
      a solids outlet in a lower portion of the settling tank,
      an adjustable weir outlet configured to control outflow of brine from an upper portion of the settling tank,
      a brine inlet configured to introduce brine into the settling tank, and
      a reagent inlet configured to introduce a pH-adjusting reagent from a source of the pH-adjusting reagent into the settling tank to be mixed with the brine;
   wherein a first brine mineral precipitator of the plurality of brine mineral precipitators receives brine from an initial brine source through its brine inlet, and wherein subsequent brine mineral precipitators in the series receive brine from the adjustable weir outlet of a previous brine mineral precipitator in the series.
22. The brine mineral precipitator of any of examples 1-20, or the system of any of examples 21-38, or the method of any of examples 39-62, wherein one or more of the brine mineral precipitators is configured to increase or reduce the pH of the brine compared to a previous brine mineral precipitator.
23. The brine mineral precipitator of any of examples 1-20, or the system of any of examples 21-38, or the method of any of examples 39-62, wherein one or more of the brine mineral precipitators comprises a pH sensor configured to measure a pH of brine in the settling tank.
24. The brine mineral precipitator of any of examples 1-20, or the system of any of examples 21-38, or the method of any of examples 39-62, further comprising a controller in communication with the pH sensor configured to change an amount of the pH-adjusting reagent that is introduced into the settling tank to achieve a predetermined pH level in the brine.
25. The brine mineral precipitator of any of examples 1-20, or the system of any of examples 21-38, or the method of any of examples 39-62, wherein one or more of the brine mineral precipitators comprises a temperature sensor configured to measure a temperature of brine in the settling tank.
26. The brine mineral precipitator of any of examples 1-20, or the system of any of examples 21-38, or the method of any of examples 39-62, wherein one or more of the brine mineral precipitators comprises a plurality of heat exchange tubes extending inward from an outer wall of the settling tank configured to heat or cool the brine in the settling tank.
27. The brine mineral precipitator of any of examples 1-20, or the system of any of examples 21-38, or the method of any of examples 39-62, further comprising a controller in communication with the temperature sensor configured to adjust the heating or cooling of the brine to achieve a predetermined temperature in the brine.
28. The brine mineral precipitator of any of examples 1-20, or the system of any of examples 21-38, or the method of any of examples 39-62, wherein the initial brine source comprises a body of salt water.
29. The brine mineral precipitator of any of examples 1-20, or the system of any of examples 21-38, or the method of any of examples 39-62, wherein the body of salt water comprises a salt lake or a salt playa.
30. The brine mineral precipitator of any of examples 1-20, or the system of any of examples 21-38, or the method of any of examples 39-62, wherein the outlet of a final brine mineral precipitator of the series is connected to the body of salt water to return the brine to the body of salt water.
31. The brine mineral precipitator of any of examples 1-20, or the system of any of examples 21-38, or the method of any of examples 39-62, wherein the brine has a lower salinity when returned to the body of salt water than when initially removed from the body of salt water.
32. The brine mineral precipitator of any of examples 1-20, or the system of any of examples 21-38, or the method of any of examples 39-62, wherein the plurality of brine mineral precipitators comprise one or more brine mineral precipitators configured to precipitate a mineral selected from the group consisting of: struvite, magnesium carbonate, heavy metal hydroxide, colemanite, calcium carbonate, lithium carbonate, magnesium oxide, potassium sulfate, potassium chloride, sodium carbonate, magnesium chloride, magnesium sulfate, anhydrous sodium sulfate, and combinations thereof.
33. The brine mineral precipitator of any of examples 1-20, or the system of any of examples 21-38, or the method of any of examples 39-62, wherein the plurality of brine mineral precipitators comprise two or more of the following brine mineral precipitators connected in series in this relative order: (1) a struvite precipitator, (2) a magnesium carbonate precipitator, (3) a heavy metal hydroxide precipitator, (4) a colemanite precipitator, (5) a calcium carbonate precipitator, (6) a lithium carbonate precipitator, (7) a magnesium oxide precipitator, (8) a potassium sulfate precipitator, (9) a potassium chloride precipitator, (10) a sodium carbonate precipitator, (11) a magnesium chloride precipitator, (12) a magnesium sulfate precipitator, and (13) an anhydrous sodium sulfate precipitator.
34. The brine mineral precipitator of any of examples 1-20, or the system of any of examples 21-38, or the method of any of examples 39-62, wherein:
   (1) the struvite precipitator contains brine at a pH from 8.0 to 9.0; or
   (2) the magnesium carbonate precipitator contains brine at a pH from 8.5 to 9.5 and injected carbon dioxide; or
   (3) the heavy metal hydroxide precipitator contains brine at a pH from 8.5 to 9.5; or
   (4) the colemanite precipitator contains brine at a pH from 9.2 to 9.5 and injected calcium hydroxide seeding agent; or
   (5) the calcium carbonate precipitator contains brine at a pH from 9.5 to 10.0 and a flocculant; or
   (6) the lithium carbonate precipitator contains brine at a pH from 10.5 to 11.0; or
   (7) the magnesium oxide precipitator contains brine at a pH from 10.5 to 11.5; or
   (8) the potassium sulfate precipitator contains brine at a pH from 7.0 to 8.0 and an injected coagulant; or
   (9) the potassium chloride precipitator contains brine at a pH from 7.0 to 8.0 and an injected flocculant; or
   (10) the sodium carbonate precipitator contains brine at a pH from 10.0 to 11.0; or
   (11) the magnesium chloride precipitator contains brine at a pH from 7.0 to 8.0 and injected non-ionic polyacrylamide; or
   (12) the magnesium sulfate precipitator contains brine at a pH from 7.0 to 8.0 and injected flocculant; or
   (13) the anhydrous sodium sulfate precipitator contains brine at a pH from 7.0 to 8.0; or a combination thereof.
35. The brine mineral precipitator of any of examples 1-20, or the system of any of examples 21-38, or the method of any of examples 39-62, wherein:
   (8) the potassium sulfate precipitator maintains the brine at a temperature from 15° C. to 20° C.; or
   (9) the potassium chloride precipitator maintains the brine at a temperature from 10° C. to 12° C.; or
   (11) the magnesium chloride precipitator maintains the brine at a temperature from 4° C. to 6° C.; or
   (12) the magnesium sulfate precipitator maintains the brine at a temperature from 0° C. to 5° C.; or
   (13) the anhydrous sodium sulfate precipitator maintains the brine at a temperature below 0° C.; or the remaining precipitators maintain the brine at a temperature above 20° C.; or a combination thereof.
36. The brine mineral precipitator of any of examples 1-20, or the system of any of examples 21-38, or the method of any of examples 39-62, further comprising an electrolysis unit connected downstream of the series of brine mineral precipitators, wherein the electrolysis unit is configured to recover sodium hydroxide from the brine by electrolysis.
37. The brine mineral precipitator of any of examples 1-20, or the system of any of examples 21-38, or the method of any of examples 39-62, further comprising a real-time AI-driven process control adapted to optimize reagent dosing and mineral recovery yields.
38. The brine mineral precipitator of any of examples 1-20, or the system of any of examples 21-38, or the method of any of examples 39-62, wherein the plurality of brine mineral precipitators are arranged in a spiral pattern.
39. A brine mineral extraction method, comprising:
   introducing brine into a settling tank of a brine mineral precipitator;
   introducing a pH-adjusting reagent into the settling tank;
   mixing the pH-adjusting reagent with the brine to adjust the pH of the brine, wherein a mineral precipitates from the brine at the adjusted pH;
   allowing the precipitated mineral to settle to a lower portion of the settling tank;
   recovering the precipitated mineral at a solids outlet in the lower portion of the settling tank; and
   flowing the brine out from an upper portion of the settling tank through an adjustable weir outlet.
40. The brine mineral precipitator of any of examples 1-20, or the system of any of examples 21-38, or the method of any of examples 39-62, further comprising:
   flowing the brine from the adjustable weir outlet to a plurality of additional brine mineral precipitators in series;
   introducing pH-adjusting reagents into settling tanks of the plurality of additional brine mineral precipitators;
   mixing the pH-adjusting reagents with the brine to precipitate additional minerals from the brine; and
   recovering the additional minerals at solids outlets in lower portions of the additional brine mineral precipitators.
41. The brine mineral precipitator of any of examples 1-20, or the system of any of examples 21-38, or the method of any of examples 39-62, wherein the brine is introduced from an initial brine source comprising a body of salt water.
42. The brine mineral precipitator of any of examples 1-20, or the system of any of examples 21-38, or the method of any of examples 39-62, wherein the body of salt water comprises a salt lake or a salt playa.
43. The brine mineral precipitator of any of examples 1-20, or the system of any of examples 21-38, or the method of any of examples 39-62, further comprising recovering a produced water from a hydrocarbon fired power generation system, wherein the produced water comprises one or more of carbonic acid, nitric acid, and sulfuric acid, wherein the pH-adjusting reagent comprises the produced water.
44. The brine mineral precipitator of any of examples 1-20, or the system of any of examples 21-38, or the method of any of examples 39-62, further comprising returning the brine to the body of salt water after flowing the brine out through the adjustable weir outlet.
45. The brine mineral precipitator of any of examples 1-20, or the system of any of examples 21-38, or the method of any of examples 39-62, wherein the brine has a lower salinity when returned to the body of salt water than when initially removed from the body of salt water.
46. The brine mineral precipitator of any of examples 1-20, or the system of any of examples 21-38, or the method of any of examples 39-62, wherein the precipitated mineral comprises a mineral selected from the group consisting of: struvite, magnesium carbonate, heavy metal hydroxide, colemanite, calcium carbonate, lithium carbonate, magnesium oxide, potassium sulfate, potassium chloride, sodium carbonate, magnesium chloride, magnesium sulfate, anhydrous sodium sulfate, and combinations thereof.
47. The brine mineral precipitator of any of examples 1-20, or the system of any of examples 21-38, or the method of any of examples 39-62, wherein the precipitated mineral comprises struvite and the adjusted pH is from 8.0 to 9.0; or wherein the precipitated mineral comprises magnesium carbonate and the adjusted pH is from 8.5 to 9.5; or wherein the precipitated mineral comprises heavy metal hydroxide and the adjusted pH is from 8.5 to 9.5; or wherein the precipitated mineral comprises colemanite and the adjusted pH is from 9.2 to 9.5; or wherein the precipitated mineral comprises calcium carbonate and the adjusted pH is from 9.5 to 10.0; or wherein the precipitated mineral comprises lithium carbonate and the adjusted pH is from 10.5 to 11.0; or wherein the precipitated mineral comprises magnesium oxide and the adjusted pH is from 10.5 to 11.5; or wherein the precipitated mineral comprises potassium sulfate and the adjusted pH is from 7.0 to 8.0; or wherein the precipitated mineral comprises potassium chloride and the adjusted pH is from 7.0 to 8.0; or wherein the precipitated mineral comprises sodium carbonate and the adjusted pH is from 10.0 to 11.0; or wherein the precipitated mineral comprises magnesium chloride and the adjusted pH is from 7.0 to 8.0; or wherein the precipitated mineral comprises magnesium sulfate and the adjusted pH is from 7.0 to 8.0; or wherein the precipitated mineral comprises anhydrous sodium sulfate and the adjusted pH is from 7.0 to 8.0.
48. The brine mineral precipitator of any of examples 1-20, or the system of any of examples 21-38, or the method of any of examples 39-62, wherein the precipitated mineral comprises potassium sulfate and the method comprises maintaining the brine at a temperature from 15° C. to 20° C.; or wherein the precipitated mineral comprises potassium chloride and the method comprises maintaining the brine at a temperature from 10° C. to 12° C.; or wherein the precipitated mineral comprises magnesium chloride and the method comprises maintaining the brine at a temperature from 4° C. to 6° C.; or wherein the precipitated mineral comprises magnesium sulfate and the method comprises maintaining the brine at a temperature from 0° C. to 5° C.; or wherein the precipitated mineral comprises anhydrous sodium sulfate and the method comprises maintaining the brine at a temperature below 0° C.
49. The brine mineral precipitator of any of examples 1-20, or the system of any of examples 21-38, or the method of any of examples 39-62, wherein the precipitated mineral comprises magnesium carbonate and the method comprises injecting carbon dioxide into the brine; or wherein the precipitated mineral comprises colemanite and the method comprises injecting calcium hydroxide seeding agent into the brine; or wherein the precipitated mineral comprises calcium carbonate and the method comprises injecting a flocculant into the brine; or wherein the precipitated mineral comprises potassium sulfate and the method comprises injecting a coagulant into the brine; or wherein the precipitated mineral comprises potassium chloride and the method comprises injecting a flocculant into the brine; or wherein the precipitated mineral comprises magnesium chloride and the method comprises injecting non-ionic polyacrylamide into the brine; or wherein the precipitated mineral comprises magnesium sulfate and the method comprises injecting a flocculant into the brine.
50. A brine mineral extraction method, comprising:
   introducing brine from a brine source into a settling tank, wherein the brine source has a pH that is variable over time;
   measuring a pH of the brine in the settling tank;
   introducing a sufficient amount of a pH-adjusting reagent into the settling tank to selectively precipitate a mineral from the brine, wherein the amount of pH-adjusting reagent introduced is automatically controlled using a feedback loop with the measured pH of the brine in the settling tank;
   allowing the precipitated mineral to settle to a lower portion of the settling tank;
   recovering the precipitated mineral at a solids outlet in the lower portion of the settling tank; and
   recovering the brine from an upper portion of the settling tank.
51. The brine mineral precipitator of any of examples 1-20, or the system of any of examples 21-38, or the method of any of examples 39-62, wherein the brine source has a pH from 6.0 to 11.0.
52. The brine mineral precipitator of any of examples 1-20, or the system of any of examples 21-38, or the method of any of examples 39-62, wherein introducing the pH-adjusting reagent reduces the pH of the brine.
53. The brine mineral precipitator of any of examples 1-20, or the system of any of examples 21-38, or the method of any of examples 39-62, wherein the pH-adjusting reagent comprises carbon dioxide.
54. The brine mineral precipitator of any of examples 1-20, or the system of any of examples 21-38, or the method of any of examples 39-62, wherein introducing the pH-adjusting reagent increases the pH of the brine.
55. The brine mineral precipitator of any of examples 1-20, or the system of any of examples 21-38, or the method of any of examples 39-62, wherein the pH-adjusting reagent comprises sodium hydroxide, sodium carbonate, calcium hydroxide, magnesium hydroxide, potassium hydroxide, ammonium hydroxide, barium hydroxide, or combinations thereof.
56. The brine mineral precipitator of any of examples 1-20, or the system of any of examples 21-38, or the method of any of examples 39-62, further comprising recovering a produced water from a hydrocarbon fired power generation system, wherein the produced water comprises one or more of carbonic acid, nitric acid, and sulfuric acid, wherein the pH-adjusting reagent comprises the produced water.
57. The brine mineral precipitator of any of examples 1-20, or the system of any of examples 21-38, or the method of any of examples 39-62, further comprising measuring a temperature of the brine in the settling tank, heating or cooling the brine using a heat exchanger in the settling tank, and maintaining the brine in a pre-determined temperature range, wherein the heating or cooling is automatically controlled using a feedback loop with the measured temperature.
58. A brine mineral extraction method, comprising:
   introducing brine into a series of brine mineral precipitators, wherein the individual brine precipitators comprise heat exchangers;
   heating or cooling the brine in the brine mineral precipitators using the heat exchangers;
   precipitating a mineral from the brine in the brine mineral precipitator;
   separating the mineral from the brine; and
   recovering at least a portion of water vapor from the heat exchangers, the brine mineral precipitators, or both, as liquid water;
   wherein the recovering of the water vapor is accomplished using mechanical vapor recompression (MVR), thermal vapor recompression (TVR), or a combination thereof.
59. The brine mineral precipitator of any of examples 1-20, or the system of any of examples 21-38, or the method of any of examples 39-62, wherein the recovered portion of the water vapor is from 90% to 98% of a total amount of water vapor generated by the method.
60. The brine mineral precipitator of any of examples 1-20, or the system of any of examples 21-38, or the method of any of examples 39-62, wherein the liquid water is reused in the heat exchangers or the brine mineral precipitators, or released into a body of salt water, or a combination thereof.
61. The brine mineral precipitator of any of examples 1-20, or the system of any of examples 21-38, or the method of any of examples 39-62, wherein at least a portion of the liquid water is released into a body of salt water to reduce a salinity level of the body of salt water.
62. The brine mineral precipitator of any of examples 1-20, or the system of any of examples 21-38, or the method of any of examples 39-62, wherein the heating comprises utilizing industrial waste heat, waste heat from a datacenter, heat from solar energy, or a combination thereof.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A brine mineral precipitator comprising:
a settling tank;
a solid collection mechanism in a lower portion of the settling tank;
a solids outlet in the lower portion of the settling tank;
an adjustable weir outlet configured to control outflow of brine from an upper portion of the settling tank;
a recirculation pathway operatively coupled to a recirculation pump configured to draw brine and solids upward from the lower portion to the upper portion of the settling tank;
a brine inlet connected to the recirculation pathway and to a brine source, configured to direct brine into the recirculation pathway; and
a reagent inlet connected to the recirculation pathway and to a source of a pH-adjusting reagent, configured to inject the pH-adjusting reagent into the recirculation pathway to be mixed with the brine.

2. The brine mineral precipitator of claim 1, further comprises a diffuse air inlet in the lower portion of the settling tank.

3. The brine mineral precipitator of claim 1, further comprising a corrosion-resistant lining on an interior surface of the settling tank, wherein the corrosion-resistant lining comprises nylon, epoxy resin, or a combination thereof.

4. The brine mineral precipitator of claim 1, wherein the solids collection mechanism is one or more of a clarifier rake, traveling scraper, chain and flight collector, plow assembly, conical bottom floor, floor sludge hopper, sludge pump, hydrocyclone assisted underflow, jet assisted underflow, screw conveyor, inclined plates, and filter media.

5. The brine mineral precipitator of claim 1, further comprising a pH sensor configured to measure a pH of brine in the settling tank.

6. The brine mineral precipitator of claim 5, further comprising a controller in communication with the pH sensor configured to change an amount of the pH-adjusting reagent that is injected into the recirculation pathway to achieve a predetermined pH level in the brine.

7. The brine mineral precipitator of claim 1, further comprising a temperature sensor configured to measure a temperature of brine in the settling tank.

8. The brine mineral precipitator of claim 1, wherein the pH-adjusting reagent comprises carbon dioxide, a liquid solution, or a combination thereof.

9. The brine mineral precipitator of claim 1, wherein the reagent inlet is a gaseous reagent inlet configured to inject one or more gaseous reagents into the recirculation pathway.

10. The brine mineral precipitator of claim 9, further comprising a liquid reagent inlet connected to the recirculation pathway and to a source of a liquid reagent, configured to inject the liquid reagent into the recirculation pathway to be mixed with the brine.

11. The brine mineral precipitator of claim 10, wherein the liquid reagent comprises a catalyst, a seeding agent, a coagulant, a flocculant, an anti-scaling agent, an anti-fouling agent, an anti-foaming agent, a base, an acid, or a combination thereof.

12. The brine mineral precipitator of claim 1, further comprising a plurality of heat exchange tubes extending inward from an outer wall of the settling tank configured to heat or cool the brine in the settling tank.

13. The brine mineral precipitator of claim 12, wherein the heat exchange tubes comprise serrated fins extending radially from the heat exchange tubes.

14. The brine mineral precipitator of claim 1, wherein the recirculation pathway is a draft tube centrally oriented within the settling tank.

15. A brine processing system, comprising:
a plurality of brine mineral precipitators connected in series, wherein individual brine mineral precipitators comprise:
a settling tank,
a solids outlet in a lower portion of the settling tank,
an adjustable weir outlet configured to control outflow of brine from an upper portion of the settling tank,
a brine inlet configured to introduce brine into the settling tank, and
a reagent inlet configured to introduce a pH-adjusting reagent from a source of the pH-adjusting reagent into the settling tank to be mixed with the brine;
wherein a first brine mineral precipitator of the plurality of brine mineral precipitators receives brine from an initial brine source through its brine inlet, and wherein subsequent brine mineral precipitators in the series receive brine from the adjustable weir outlet of a previous brine mineral precipitator in the series.

16. The system of claim 15, wherein one or more of the brine mineral precipitators is configured to increase or reduce pH of the brine compared to a previous brine mineral precipitator, and wherein one or more of the brine mineral precipitators comprises a pH sensor configured to measure a pH of brine in the settling tank.

17. The system of claim 16, further comprising a controller in communication with the pH sensor configured to change an amount of the pH-adjusting reagent that is introduced into the settling tank to achieve a predetermined pH level in the brine.

18. The system of claim 15, wherein one or more of the brine mineral precipitators comprises a temperature sensor configured to measure a temperature of brine in the settling tank.

19. The system of claim 18, wherein one or more of the brine mineral precipitators comprises a plurality of heat exchange tubes extending inward from an outer wall of the settling tank configured to heat or cool the brine in the settling tank.

20. The system of claim 19, further comprising a controller in communication with the temperature sensor configured to adjust the heating or cooling of the brine to achieve a predetermined temperature in the brine.

21. The system of claim 15, wherein the initial brine source comprises a body of salt water which is a salt lake or a salt playa.

22. The system of claim 21, wherein the outlet of a final brine mineral precipitator of the series is connected to the body of salt water to return the brine to the body of salt water, wherein the brine has a lower salinity when returned to the body of salt water than when initially removed from the body of salt water.

23. The system of claim 15, wherein the plurality of brine mineral precipitators are arranged in a spiral pattern to minimize footprint and optimize flow path length.

24. The system of claim 15, wherein the plurality of brine mineral precipitators comprise one or more brine mineral precipitators configured to precipitate a mineral selected from the group consisting of: struvite, magnesium carbonate, heavy metal hydroxide, colemanite, calcium carbonate, lithium carbonate, magnesium oxide, potassium sulfate, potassium chloride, sodium carbonate, magnesium chloride, magnesium sulfate, anhydrous sodium sulfate, and combinations thereof.

25. The system of claim 15, wherein the plurality of brine mineral precipitators comprise two or more brine mineral precipitators connected in series in this relative order: (1) a struvite precipitator, (2) a magnesium carbonate precipitator, (3) a heavy metal hydroxide precipitator, (4) a colemanite precipitator, (5) a calcium carbonate precipitator, (6) a lithium carbonate precipitator, (7) a magnesium oxide precipitator, (8) a potassium sulfate precipitator, (9) a potassium chloride precipitator, (10) a sodium carbonate precipitator, (11) a magnesium chloride precipitator, (12) a magnesium sulfate precipitator, and (13) an anhydrous sodium sulfate precipitator.

26. The system of claim 25, wherein:
(1) the struvite precipitator contains brine at a pH from 8.0 to 9.0; or
(2) the magnesium carbonate precipitator contains brine at a pH from 8.5 to 9.5 and injected carbon dioxide; or
(3) the heavy metal hydroxide precipitator contains brine at a pH from 8.5 to 9.5; or
(4) the colemanite precipitator contains brine at a pH from 9.2 to 9.5 and injected calcium hydroxide seeding agent; or
(5) the calcium carbonate precipitator contains brine at a pH from 9.5 to 10.0 and a flocculant; or
(6) the lithium carbonate precipitator contains brine at a pH from 10.5 to 11.0; or
(7) the magnesium oxide precipitator contains brine at a pH from 10.5 to 11.5; or
(8) the potassium sulfate precipitator contains brine at a pH from 7.0 to 8.0 and an injected coagulant; or
(9) the potassium chloride precipitator contains brine at a pH from 7.0 to 8.0 and an injected flocculant; or
(10) the sodium carbonate precipitator contains brine at a pH from 10.0 to 11.0; or
(11) the magnesium chloride precipitator contains brine at a pH from 7.0 to 8.0 and injected non-ionic polyacrylamide; or
(12) the magnesium sulfate precipitator contains brine at a pH from 7.0 to 8.0 and injected flocculant; or
(13) the anhydrous sodium sulfate precipitator contains brine at a pH from 7.0 to 8.0; or a combination thereof.

27. The system of claim 25, wherein:
(8) the potassium sulfate precipitator maintains the brine at a temperature from 15° C. to 20° C.; or
(9) the potassium chloride precipitator maintains the brine at a temperature from 10° C. to 12° C.; or
(11) the magnesium chloride precipitator maintains the brine at a temperature from 4° C. to 6° C.; or
(12) the magnesium sulfate precipitator maintains the brine at a temperature from 0° C. to 5° C.; or
(13) the anhydrous sodium sulfate precipitator maintains the brine at a temperature below 0° C.; or remaining precipitators maintain the brine at a temperature above 20° C.; or a combination thereof.
